(19) United States
(12) Patent Application Publication
(10) Pub. No.: US 2025/0003551 A1
(43) Pub. Date: Jan. 2, 2025

(54) SMART LUBRICATION SYSTEM

(71) Applicant: Aykut Özdemir, Eskisehir (TR)

(72) Inventor: Aykut Özdemir, Eskisehir (TR)

(21) Appl. No.: 18/703,830

(22) PCT Filed: Jul. 6, 2022
(86) PCT No.: PCT/TR2022/050706

§ 371 Date: Apr. 23, 2024

(51) Int. Cl. F16N 29/02; G05B 19/05

(52) U.S. Cl. CPC F16N 29/02; G05B 19/05; F16N 2230/00

(57) ABSTRACT

This invention relates to a smart lubrication system containing a pre-constructed database of manual regular lubrication tasks, software, hardware, a basic unit ensuring the lubrication to be performed when necessary and in the necessary volume, industrial PC, lubrication points database, battery charger, main unit user monitor, mobile lubrication unit, UPS and battery group, operator's monitor, PLC unit, lubrication point (Tag ID) recognition module, grease pump unit, flow (lubricant volume) meter, lubrication hose and Tag ID reader cable, lubrication point Tag ID (Chip), lubrication coupling, lubrication nipple, and greasing block.

### TECHNICAL FIELD

This invention ensures regular lubrication tasks, normally performed manually in factories, to be performed when necessary and with required volumes by means of a database, software and hardware.

### Present State of Technique

Regular lubrication tasks at factories are generally performed by employing two different methods:
1-) Manual lubrication by pumps operated manually, electrically or pneumatically.
2-) Centralized lubrication systems consist of a pump, lubricant distributor valves and distribution pipes/hoses.

### PURPOSE OF INVENTION

This invention eliminates most of the human related errors. It ensures each point to be lubricated within the most suitable period of time and in the most suitable volume.

The software determines the volume of lubricant to be delivered to the lubrication point, so that it prevents the use of lesser or more lubricant depending on individual operator.

It ensures each point to be lubricated with the correct lubricant to avoid the risk of using incorrect lubricant.

Maintenance team in charge of manual lubrication will only connect the mobile unit to lubrication point. Lubrication task will be automatically performed by this invention.

Completed or incomplete lubrication tasks are stored in the database and informed by e-mail automatically and regularly to the management.

It ensures the factory's lubrication performance to be monitored in a continuous way. It ensures lubricant consumption and inventory to be managed in an easy and accurate way.

It prevents various problems from arising due to human error or misunderstanding and ensures all works to be reported in a transparent and accurate way.

### DESCRIPTION OF FIGURES

FIG. 1 Flowchart of the smart lubrication system process

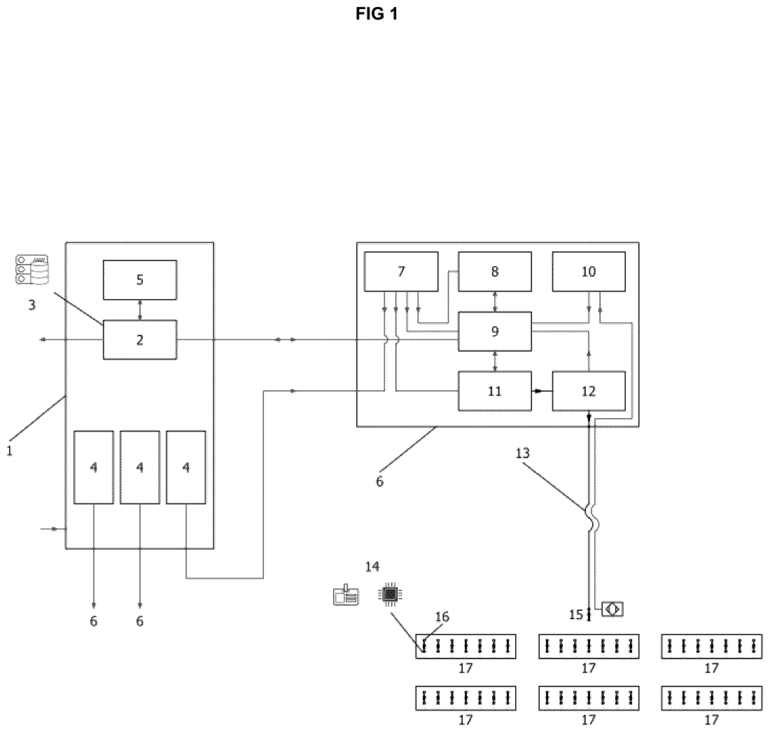

### DESCRIPTION OF NUMBERS

1—Basic unit
2—Industrial PC
3—Database for lubrication points
4—Battery charger
5—Basic unit monitor
6—Mobile lubrication unit
7—UPS and battery group
8—Operator's monitor
9—PLC unit
10—Lubrication point (Tag ID) recognition module
11-Grease pump unit
12—Flow (lubricant volume) meter
13—Lubrication hose and Tag ID reader cable
14—Lubrication point Tag ID (Chip)
15—Lubrication coupling
16—Lubrication nipple
17—Greasing block

### DESCRIPTION OF INVENTION

Each lubrication point that will be part of this program is assigned with a Tag ID chip (14). Tag ID chips are embedded in the greasing block (17). These IDs are stored in the main database (3) with lubrication intervals, lubricant type and lubricant amount required for each time.

The lubrication point database (3) is converted into work orders by the software running in the industrial PC (2) of the main unit. These work orders are transferred from the main unit (1) to the PLC (9) of the mobile lubrication unit (6) via data transfer cable. Same cable harness is also used for re-charging the batteries (7).

Once the transfer of the work order and charging is completed, mobile lubrication unit (6) is ready to operate without the need for external power or air. It can be used up to approximately 8 hours with the internal battery pack (7). Thus the operator can detach the mobile lubrication unit (6) from the main unit (1), take it to the field and perform the lubrication tasks listed in the work order.

The mobile lubrication unit (6) consists of an electric grease pump (11), a flow (lubricant volume) meter (12), an UPS and battery group (7), a PLC unit (9) and an HMI operator's monitor (8).

When mobile unit (6) is near the lubrication point, operator will connect the lubrication coupler (15) of the lubrication hose (13) to the greasing nipple with Tag ID chip (14). Signal return cable that is integrated to the hose (13) will also be connected to the magnetic plate located on the greasing block for communication.

The lubrication point Tag ID (Chip) (14) contains a special greasing block (17) equipped with a chip. After the lubrication point, Tag ID reader cable (13) and the greasing block (17) are connected to each other, communication will be established. At this stage, lubrication point will be identified and confirmed whether it is part of the work order. System will give warning message on the operator panel (8) if the lubrication point can't be identified or verified. If the lubrication point is verified, lubrication task will start automatically and “ok” message will be displayed on operators panel (8) upon completion. If there is an interruption during the lubrication, system, will keep the status of the delivered amount and will allow operator to complete the task.

If the operator connects the lubrication coupling (15) to the same point again by mistake, system will give a warning message and prompt the operator whether additional lubrication is needed. If the operator chose to lubricate despite the warning, total amount of lubricant that is delivered will be reported.

After all work orders are performed, the mobile lubrication unit (6) will be reattached to the main unit (1). Thus completed tasks (or incomplete tasks) are transferred to the main unit (1) and the charging process will be automatically started.

Amendments to the claims:

1. A smart lubrication system, comprising:
a database of lubrication points with:
pre-calculated lubrication intervals,
lubricant amounts and lubricant types,
database management software,
PLC software, and
firmware and necessary-hardware;
a main unit adapted to ensure that lubrication is performed when desired and in a desired volume,
an industrial PC,
a battery charger,
a main unit user monitor,
a mobile lubrication unit,
a UPS and battery group,
an operator's monitor,
a PLC unit,
a lubrication point (Tag ID) recognition module ,
a grease pump unit,
a flow (lubricant volume) meter,
a lubrication hose and Tag ID reader cable,
a lubrication points Tag ID (Chip),
a lubrication coupling,
a lubrication nipple, and
a greasing block.

2. The smart lubrication system of claim 1, comprising a basic unit that can convert the database of lubrication points to work orders by means of a software program running on an the industrial PC.

3. The smart lubrication system of claim 1, wherein the UPS and battery group are adapted to ensure the mobile lubrication unit runs without a need of external power (electricity or pressurized air).

4. The smart lubrication system of claim 1, wherein the mobile lubrication unit comprises an electric grease pump, the flow (lubricant volume) meter, the UPS and battery group, the PLC unit, and the operator's monitor.

5. A method for using a smart lubrication system, the method comprising:
storing data from a Tag ID (Chip) of all lubrication points which must be lubricated with a certain volume of lubricant at regular intervals in a lubrication point database;
converting data stored in the lubrication point database are converted to work orders by a software program running on an industrial PC located in a basic unit;
transferring the work orders from the basic unit to a PLC located in a mobile lubrication unit;
detaching the mobile lubrication unit from the basic unit and taking the mobile lubrication unit to a remote location;
moving the mobile lubrication unit next to the Tag ID (Chip);
connecting the mobile lubrication unit and the Tag ID (Chip) with a lubrication hose;
attaching the lubrication hose and a Tag ID reader cable to a special greasing block containing a chip that is adapted to identify the Tag ID (Chip);
confirming accuracy of a type of lubricant to be used-is confirmed,;
automatically delivering lubricant in a pre-determined volume;
reattaching the mobile lubrication unit to the basic unit;
transferring at least one of completed tasks and (or incomplete tasks) are transferred to the basic unit; and
automatically starting a charging process for the mobile lubrication unit.
